(19) United States
(12) Patent Application Publication
(10) Pub. No.: US 2008/0161470 A1
(43) Pub. Date: Jul. 3, 2008

(54) Composition comprising polyvinyl chloride and elastomer

(76) Inventors: Stewart Carl Feinberg, Exton, PA (US); David J. Walsh, Chadds Ford, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/647,981

(22) Filed: Dec. 28, 2006

(51) Int. Cl. C08K 3/40; C08K 11/00; C08K 3/26; C08K 3/22; C08K 3/34; C08K 3/36

(52) U.S. Cl. 524/425; 524/445; 524/451; 524/523; 524/430; 524/442; 524/449; 524/522

(57) ABSTRACT

Disclosed is a composition comprising, consisting essentially of, consisting of, or produced from polyvinyl chloride, filler, and an impact strength-retaining amount of an elastomer wherein the modifier is or includes an ethylene copolymer, or acid anhydride- or acid monoester-modified polyolefin, or combinations thereof. Also disclosed is a process comprising combining an impact strength-retaining amount of an elastomer to a blend that comprises or is produced by combining a rigid PVC formulation and one or more fillers. The combining is carried out under a condition sufficient to prevent or minimize the reduction of impact strength of the blend, to reduce the molten viscosity of the blend, or to minimize the loss in stiffness (flexural modulus) of the blend, in comparison to the unmodified blend.

The invention relates to a composition comprising polyvinyl chloride and ethylene elastomer and to a product therewith.

Because PVC is a hard, brittle thermoplastic material, almost all PVC is impact-modified to some extent. Recently there has been an increased interest in composition of wood and PVC, particularly for use in home siding applications. Such composites are highly desirable because they resemble traditional wood siding. Moreover, such composition raises the sag temperature of PVC and thus permits the use of dark colors in the composite siding. See, e.g., U.S. Pat. Nos. 6,011,091, 6,103,791, and 6,066,680, and US Patent Application 2003/0229160.

To broaden markets and opportunities for PVC, various reinforcing fillers such as fiberglass or minerals are compounded into rigid PVC formulations in order to increase the stiffness (flexural modulus) of the polymer. Unfortunately, other physical properties are degraded by the addition of the reinforcing filler, usually in direct proportion to the amount of such filler that is added. Consequently, end users of the rigid PVC formulations are constantly searching for additives that prevent or minimize the reduction of such desirable properties. It is also desirable to prevent or minimize the loss of impact properties of the PVC, to improve or reduce the molten viscosity, or to minimize the loss in stiffness of PVC (as compared to the unmodified PVC).

### SUMMARY OF THE INVENTION

The invention includes a composition comprising, consisting essentially of, consisting of, or produced from polyvinyl chloride, filler, an impact strength-retaining amount of an acrylate elastomer, and optionally an ethylene copolymer.

The invention also includes a process comprising combining an impact strength-retaining amount of an elastomer and optionally an ethylene copolymer to a blend wherein the blend comprises or is produced by combining a rigid PVC formulation and one or more fillers and the combining is carried out under a condition sufficient to prevent or minimize the reduction of impact strength of the blend, to reduce the molten viscosity of the blend, or to minimize the loss in stiffness (flexural modulus) of the blend, in comparison to the unmodified blend.

Further included is a process, which comprises combining an impact strength-retaining amount of an elastomer and a filler to produce a mixture and combining the mixture with PVC to produce the composition. If the elastomer comprises a cure site monomer, the elastomer can be crosslinked prior, during, or subsequent to the combining of the elastomer, filler, and PVC or of the combination of the mixture and the PVC.

### DETAILED DESCRIPTION OF THE INVENTION

Any filler or additive that may improve the stiffness of PVC may be used. Examples of such fillers include, but are not limited to, one or more glass fibers, hollow glass microspheres, inorganic compounds, such as minerals and salts including CaCO₃, silica, silicates such as calcium silicate or metasilicate, bentonite clay, mica, talc, alumina trihydrate, magnesium hydroxide, metal oxides, or combinations of two or more thereof. The filler can be present in an amount that is sufficient to improve the stiffness of PVC and can be about 0.001 to about 50, preferably, about 1 to about 25%, or more preferably, from about 2 to about 15%, by weight of the resulting blend.

An elastomer can include acrylic elastomers such as poly(meth)acrylate, polyethylene (meth)acrylate, polyperfluoro (meth)acrylate, polyalkyl(meth)acrylate, polyethylene alkyl (meth)acrylate, polyperfluoroalkyl(meth)acrylate, or combinations of two or ore thereof wherein the alkyl (meth)acrylate includes one or more C₁ to C₁₀ (meth)acrylates, which refer to acrylate, methacrylate, or both such as methyl acrylate, ethyl acrylate, n-butyl acrylate, iso-butyl acrylate, methoxymethyl acrylate, 2-ethylhexyl acrylate, octyl acrylate, methyl methacrylate, ethyl methacrylate, n-butyl methacrylate, iso-butyl methacrylate, methoxymethyl methacrylate, 2-ethylhexyl methacrylate, octyl methacrylate, or combinations of two or more thereof.

Poly(meth)acrylate comprise repeat units derived from one or more alkyl (meth)acrylates or (meth)acrylic acid, and optionally an acid cure site monomer. Alkyl (eth)acrylate refers to alkyl acrylate, alkyl methacrylate, or both and (meth)acrylic acid refers to acrylic acid, methacrylic acid, or both. Repeat units derived from alkyl(meth)acrylate can be about 5 to about 60, about 10 to about 50, or about 10 to about 40, weight % of the copolymer.

The acid cure site monomer may be an acid, an acid anhydride, an ester of the acid such as monoalkyl ester. The acid can be a 1,4-butene-dioic acid, and its esters, which can exist in either cis- or trans-form, such as maleic acid, fumaric acid, maleic acid methyl ester, maleic acid ethyl ester, maleic acid propyl esters, maleic acid butyl esters, maleic acid pentyl ester, maleic acid hexyl esters, fumaric acid methyl ester, fumaric acid ethyl ester, fumaric acid propyl ester, or combinations of two or more thereof. Repeat units derived from acid cure site monomer can comprise from about 0.1 to about 10, about 0.5 to about 7, about 1 to about 6, or 2 to 5 weight % of the ethylene copolymer. The rest can be derived from ethylene. The quantities repeat units derived from alkyl (meth)acrylate(s) and the acid cure site monomer can be adjusted to provide the required amount of —CO₂— units in the final copolymer. The total —CO₂— units in the polymer are the sum of the ester groups in the two or more acrylate comonomers and in the 1,4-butene-dioic acid monoalkyl ester, and the acid groups in the monoalkyl ester.

Examples of polyethylene alkyl (meth)acrylates include copolymers of ethylene, methyl acrylate, and n-butyl acrylate, copolymers of ethylene, methoxymethyl acrylate (MMA), and n-butyl acrylate, copolymers of ethylene, methyl acrylate, and maleic acid ethyl monoester, copolymers of ethylene, methyl acrylate, n-butyl acrylate, and maleic acid ethyl monoester, copolymers of ethylene, methyl acrylate, iso-butyl acrylate, and maleic acid ethyl monoester, copolymers of ethylene, methyl acrylate, and 2-ethylhexyl acrylate. Copolymers of ethylene, methyl acrylate, 2-ethylhexyl acrylate, and maleic acid ethyl monoester, copolymers of ethylene, methyl acrylate, and n-octyl acrylate, and copolymers of ethylene, methyl acrylate, n-octyl acrylate, and maleic acid ethyl monoester.

The elastomers can be readily prepared using any methods known to one skilled in the art such as, for example, disclosed in U.S. Pat. Nos. 2,897,183, 3,883,472, 3,904,588, 4,174,358, and 5,028,674 as well as US patent application US2005/0020775, disclosures of which are incorporated herein by reference.

The elastomers can be mixed with additional materials, a process known in the art as compounding, to provide a blended composition. For example, compounding can involve combining the polymer with one or more additives such as antioxidants, internal release agents, plasticizers, accelerators, fillers (e.g., glass fibers, mica, etc.), flame retardants, or combinations of two or more thereof. Flame retardant can include any flame retardants known to one skilled in the art such as brominated polystyrene or poly (bromostyrene) (optionally with a flame retardant synergist such as antimony pentoxide, antimony trioxide, sodium antimonite, or Zinc Borate), phosphorus-containing compounds, a copolymer of a halostyrene and glycidyl(meth)acrylate, or a halogen-free thermoplastic polymer blend comprising an ethylene vinyl acetate carbon monoxide terpolymer, an ethylene vinyl acetate copolymer or a polyolefin, each of which is grafted with a carboxylic acid or anhydride thereof, and an inorganic filler. The components can be mixed in conventional equipment such as an internal mixer (e.g., a Banbury mixer), a two-roll mill and other similar mixing devices known in the art to achieve a substantially homogeneous mixture.

After compounding, a blend of the uncrosslinked copolymer and a curing agent, such as a peroxide curing system composing peroxide and optionally a coagent, along with one or more fillers and/or other additives disclosed can be subject to a curing step at sufficient time, temperature and pressure to achieve covalent chemical bonding (i.e., crosslinking). Suitable peroxides and coagents include any such curative system as generally known in the art (e.g., U.S. Pat. Nos. 2,897,183, 3,883,472, 3,904,588, 5,028,674, and 7,001,957 and US patent application US2005/0020775) including peroxide α,α-bis(t-butylperoxy)-diisopropylbenzene and coagents N,N′-(m-phenylene) dimaleamide, trimethylolpropane trimethylacrylate, tetraallyloxyethane, triallyl cyanurate, tetramethylene diacrylate, or polyethylene oxide glycol dimethacrylate.

The peroxide curing system can be employed after the elastomer has been combined with the PVC formulation. However, wishing not to be bound by theory, those skilled in the art may believe a ready degradation of PVC in the presence of peroxides, a crosslinking system that allows crosslinking of the elastomer when it is in the presence of PVC may provide a solution. Such system uses chemical compounds containing reactive hydrogen groups or epoxide groups such as dialcohols, diacids, diamines, epoxide groups, or combinations of two or more thereof.

A dialcohol or diacid or a chemical compound containing both an acid group and an alcohol group includes ethylene glycol, propane diol, butylene diol, polyethylene glycol, tartaric acid, or combinations of two or more thereof.

Diamine compounds include ethylene diamine, propylene diamine, butane diamine, hexamethlyene diamine, polyamindes, or combinations of two or more thereof.

Epoxy group-containing chemical compound include an ethylene alky(meth)acrylate copolymer containing a epoxy comonomer such as glycidyl methacrylate, glycidyl acrylate, glycidyl vinyl ether, or an epoxidized oil. Examples include ethylene/n-butyl (meth)acrylate/glycidyl (meth)acrylate terpolymer, ethylene/n-butyl (meth)acrylate/glycidyl vinyl ether terpolymer, epoxidized soybean oil, or combinations of two or more thereof.

An ethylene copolymer can also comprise repeat units derived from ethylene and alky (meth)acrylate, vinyl acetate, (meth)acrylic acid, or combinations of two or more thereof. An ethylene copolymer may comprise up to 35 wt % of an additional comonomer such as carbon monoxide, sulfur dioxide, acrylonitrile, maleic anhydride, dimethyl maleate, diethyl maleate, dibutyl maleate, dimethyl fumarate, diethyl fumarate, dibutyl fumarate, dimenthyl fumarate, maleic acid, maleic acid monoesters, itaconic acid, fumaric acid, fumaric acid monoester, a salt of these acids, glycidyl acrylate, glycidyl methacrylate, and glycidyl vinyl ether, where the ester can be one or more C₁ to C₄ alcohols (e.g., methyl, ethyl, n-propyl, isopropyl and n-butyl alcohols), combinations of two or more thereof.

Alkyl (meth)acrylate copolymers can be produced by processes well known in the art using either autoclave or tubular reactors. See e.g., U.S. Pat. Nos. 5,028,674, 2,897,183, 3,404,134, 6,500,888 and 6,518,365, the disclosures of which are incorporated herein by reference. Because the processes are well known, the disclosure of which is omitted herein for the interest of brevity. Examples of ethylene alky (meth)acrylate copolymers include ethylene methyl methacrylate, ethylene methyl acrylate, ethylene ethyl acrylate, ethylene butyl acrylate, ethylene n-butyl acrylate carbon monoxide (ENBACO), ethylene glycidyl methacrylate (EBAGMA), or combinations of two or more thereof such as Elvaloy® commercially available DuPont. A mixture of two or more different ethylene alkyl (meth)acrylate copolymers can be used.

Ethylene vinyl acetate (EVA) copolymer is a polymer well known to one skilled I the art. The relative amount of vinyl acetate comonomer incorporated into EVA can be from 0.1 weight % up to as high as 40 weight percent of the total copolymer or even higher. For example, EVA can have a vinyl acetate content of from 2 to 50% by weight, 10 to 40 %, or 6 to 30% by weight. Example of EVA copolymer also includes ethylene/vinyl acetate/carbon monoxide (EVACO). EVA may be modified by methods well known in the art, including modification with an unsaturated carboxylic acid or its derivatives, such as maleic anhydride or maleic acid. Examples of commercially available EVA includes Elvax® from DuPont.

An example of acid copolymer can be described as E/X/Y copolymer where E is ethylene, X can be at least one unsaturated carboxylic acid disclosed above, and Y is a softening comonomer such as alkyl acrylate, alkyl methacrylate, or combinations thereof. X can be present from about 3 to about 30, 4 to 25, or 5 to 20, weight % of the E/X/Y copolymer, and Y is from 0 to about 35, 0.1 to 35, or 5 to 30, weight % of the E/X/Y copolymer. Specific examples of acid copolymers include ethylene/(meth)acrylic acid copolymers, ethylene/(meth)acrylic acid/n-butyl (meth)acrylate copolymers, ethylene/(meth)acrylic acid/iso-butyl (meth)acrylate copolymers, ethylene/(meth)acrylic acid/tert-butyl (meth)acrylate copolymers, ethylene/(meth)acrylic acid/methyl (meth)acrylate copolymers, ethylene/(meth)acrylic acid/ethyl (meth)acrylate copolymers, ethylene/maleic acid and ethylene/maleic acid monoester copolymers, ethylene/maleic acid monoester/n-butyl (meth)acrylate copolymers, ethylene/maleic acid monoester/methyl (meth)acrylate copolymers, ethylene/maleic acid monoester/ethyl (meth)acrylate copolymers, or combinations of two or more thereof such as Nucrel® commercially available from DuPont.

Ionomers can be prepared from the acid copolymer by treatment with a basic compound capable of neutralizing the acid moieties of the copolymer. The acid groups may be nominally neutralized to any level from about 0.1 to about 90%, about 15 to about 80%, or about 40 to about 75% with an alkaline earth metal ion, an alkali metal ion, or a transition metal ion including Li, Na, K, Ag, Hg, Cu, Be, Mg, Ca, Sr, Ba, Cd, Sn, Pb, Fe, Co, Zn, Ni, Al, Sc, Hf, Ti, Zr, Ce, or combinations of two or more thereof. Ionomers can also be prepared with nominal neutralization levels higher than 70% as disclosed above when blended with the organic acids. Examples of commercially available ionomers include Surlynofrom DuPont.

Ionomers can also comprise repeat units derived from ethylene, (meth)acrylic acid, 0.1 to 15 weight % of a dicarboxylic acid, and an alkyl (meth)acrylate (disclosed above) as disclosed in U.S. Pat. No. 5,859,137, the disclosure of which is incorporated herein by reference.

Processes for producing acid copolymer and ionomers are well known to one skilled in the art and, the description of which is omitted herein for the interest of brevity.

An acid anhydride- or acid monoester-modified polyolefin can be polyethylene or polypropylene grafted with an acid anhydride. Polyolefin can include any polymer comprising repeat units derived from an olefin and includes polyethylene, polypropylene, polybutylene, polyisobutylene, and a copolymer of any of these polyolefins. Such copolymer can include comonomers including butene, hexene, octene, decene, dodecene, or combinations of two or more thereof.

For example, polypropylene polymers include homopolymers, random copolymers, block copolymers and terpolymers of propylene. Copolymers of propylene include copolymers of propylene with other olefins such as ethylene, 1-butene, 2-butene and the various pentene isomers, etc., and preferably copolymers of propylene with ethylene. Terpolymers of propylene include copolymers of propylene with ethylene and one other olefin. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymer of propylene and ethylene. Polypropylene refers to any or all of the polymers comprising propylene described above. PP can be produced by well known processes such as Ziegler-Natta catalyst systems. Because the processes are well known, the description of which is omitted here for the interest of brevity. Example also includes copolymer of propylene and ethylene having low levels of the ethylene monomer of between about 1% to about 6% by weight.

Acid anhydride or monoester can include maleic anhydride, itaconic anhydride, fumaric anhydride, maleic acid monoesters, itaconic monoesters, fumaric acid monoester, a salt of thereof where the ester can be one or more C₁ to C₄ alcohols (e.g., methyl, ethyl, n-propyl, isopropyl and n-butyl alcohols), combinations of two or more thereof.

Acid anhydride- or acid monoester-modified polyolefin can be produced by any means known to one skilled in the art. For example, grafts can be produced by melt extrusion of the polyolefin in the presence of both a radical initiator and acid anhydride or its monoester, in a twin-screw extruder. The polymeric backbone on which an acid anhydride (e.g., maleic anhydride) functionality is grafted can be either any polyolefins disclosed above such as LLDPE, VLDPE, mLLDPE, mVLDPE, or combinations of two or more thereof.

Acid anhydride- or acid monoester-modified polyolefin can be a direct or graft copolymer of ethylene, carbon monoxide, maleic anhydride or its functional equivalent, and a monomer including vinyl acetate, acrylic acid or its esters, methacrylic acid or its esters, or combinations of two or more thereof such as, for example, a copolymer derived from ethylene, carbon monoxide, and butyl acrylate and grafted with maleic anhydride. An example of such a polymer is FUSABOND® A MG423D (ethylene/alkyl acrylate/CO copolymer that has been modified with 1% maleic anhydride graft), available from DuPont.

Acid anhydride or acid anhydride monoester can be present in the grated polymer, based on the concentration of acid anhydride or acid anhydride monoester, ≧about 0.1, ≧about 1, ≧about 3, ≧about 4, or even ≧about 5 wt %, of the polymer being grafted.

Example of acid anhydride- or acid monoester-modified polyolefin is FUSABOND® commercially available from DuPont, which includes polyolefins having anhydride functionality such as maleic anhydride or its equivalent maleic and/or its salts, maleic acid mono- or diesters, itaconic acid, fumaric acid, and fumaric acid monoesters.

The compositions can additionally comprise, about 0.001 to about 20 weight % of the composition, one or more additives including plasticizers, stabilizers including viscosity stabilizers and hydrolytic stabilizers, antioxidants, ultraviolet ray absorbers, anti-static agents, dyes, pigments or other coloring agents, inorganic fillers, fire-retardants, lubricants, reinforcing agents such as glass fiber and flakes, foaming or blowing agents, processing aids, antiblock agents, release agents, fusion aid, process aid, calcium carbonate, calcium stearate, titanium oxide, stearic Acid, paraffin wax, lubricants, pigments, or combinations of tow or more thereof. Optional additives, when used, can be present in various quantities so long as they are not used in an amount that detracts from the basic and novel characteristics of the composition.

Compositions can be produced by any methods known to one skilled in the art such as standard mixing practices, as generally known in the art. This can be accomplished in a one-step or a two-step process. In the one-step process, all ingredients can be dry- or melt-compounded using a mixer such as Banbury mixer or twin screw or Buss kneader extruders. In the two-step process, the PVC dry blend can be first prepared in a high intensity mixer such as a Welex mixer. In the second step, the Welex blend is melt-blended with additives such as reinforcing fillers and the modifiers in a melt compounding apparatus such as a Buss Kneader or a twin screw extruder.

The composition can be formed into shaped articles using methods such as injection molding, compression molding, overmolding, or extrusion. Optionally, formed articles can be further processed. For example, pellets, slugs, rods, ropes, sheets and molded articles of the present invention may be prepared and used for feedstock for subsequent operations, such as thermoforming operations, in which the article is subjected to heat, pressure and/or other mechanical forces to produce shaped articles. Compression molding is an example of further processing.

The compositions can be cut, injection molded, compression molded, overmolded, laminated, extruded, milled or the like to provide the desired shape and size to produce commercially usable products. The resultant product may have an appearance similar to wood and may be sawed, sanded, shaped, turned, fastened and/or finished in the same manner as natural wood. It is resistant to rot and decay as well as termite attack and may be used as a replacement for natural wood, for example, as decorative moldings inside or outside of a house, railroad ties, picture frames, furniture, porch decks, railings, window moldings, window components, door components, roofing systems, sidings, or other types of structural members.

The following examples are presented to merely demonstrate and illustrate of the invention.

### EXAMPLES

### Raw Materials

The raw starting materials, their characterization and respect commercial source are summarized as follows.
PVC: Oxy 216, K—=65 (Oxyvinyls); Vista 5305, K=58 (Vista Chemical Co.).
Stabilizers: Mark 1900, methyl tin heat stabilizer (Crompton Corp.); and Irganox 1076, phenolic antioxidant (Ciba Specialty Chemical Co.).
Fusion Aid/Process Aid/Lubricant: Paraloid K120 (Rohm and Haas); calcium stearate; stearic acid; paraffin wax; and Rheolub 165 (Rohm and Haas).
Fillers and Reinforcing Agents: ChopVantage, 3790 fiberglass (PPG Industries); Nyglos 8 calcium metasilicate (also known as wollastonite) from Nyco Mineral Co.

### Welex Mixer

The following ingredients were combined in the Welex mixer: PVC powder, stabilizers, fusion aid, process aid, paraffin wax, lubricants, pigments. PVC was added to the Welex high intensity mixer and mixed under high shear over the course for about 30 minutes until the temperature reached approximately 80° C. (175° F.). At this point any liquids in the formulation were added and mixing continued. After several minutes, with the temperature at approximately 90° C. (195° F.), the rest of the ingredients were added. After approximately 5 more minutes, the machine was stopped and the contents were discharged.

### Extrusion Compounding

A Banbury or commercial thermoplastic extruder, such as a twin-screw extruder (Buss Co-kneader) was used to achieve complete admixing of the components and to give a homogenous dispersion of the components. Typical conditions for the Buss Co-kneader were: Zone 1: 110° C.; Zone 2: 180° C.; Zone 3: 180° C.; Zone 4: 180° C.; Crosshead extruder: 18.0° C.; Die: 180° C.; Crosshead RPM: 50; Buss RPM: 350; Feed rate: 10 to 20 pounds per hour; and Die: one hole, 1/16″ diameter. The filler or fillers may be added in the main feed with the other ingredients at the rear of the extruder or they may be added separately through a feed port further down the extruder. This method is referred to a adding “downstream.”

### Test Samples

Test pieces bars for flexural modulus, tensile properties, and disks (3 inch by ⅛ inch) for physical testing were molded using a single screw injection molding machine using typically the following temperature profile and conditions: Rear: 170° C.; Center: 180° C.; Front: 180° C.; Nozzle: 170° C.; Mold: 25° C.; Ram Speed: Fast; Screw Speed: 50 rpm; Injection Time: 10 seconds; Hold Time: 15 seconds; and Back Pressure: 50 psig.

Tensile properties were determined according to ASTM D638 using 5 inch by ½ inch by ⅛ inch) injection molded bars. The measurements were made on an Instron operated at a crosshead speed of 2 inch/minute. Three bars were tested. Flexural modulus was measured on 5 inch by ½ inch by ⅛ inch rectangular bars using a 2 inch span, according to ASTM D790. Three bars were tested. Notched Izod impact was determined according to ASTM D256 using the central portion of the D638 tensile bars having a 0.1 inch notch machined into the side of the bar. Five bars were tested. Determination of the Dynatup instrumented impact according to ASTM D3763 was performed in the vertical mode on 3 inch by ⅛ inch disks at Tup Size of ½ inch and drop speed of 5 mph (i.e., 10 inch drop in height with 98.2 lb load).

In the following table, control 1 was base PVC only; control 2 included base PVC, 10 parts per hundred (phr) Nyglos 8 wollastonite. Ex (example) 1 included PVC, 20 phr [50/50:PVC Welex blend shown in the table/Vamac® VCX 5500] pre-blended concentrate; Ex 2 included PVC, 20 phr [50/50:PVC Welex blend shown in the table/Vamac® VCX 5500] pre-blended concentrate crosslinked with 7.5 phr (based on Vamac®) EBAGMA; Ex 3 included PVC, 20 phr [50/50:PVC Welex blend shown in the table/Vamac® VCX 5500] pre-blended concentrate crosslinked with 1.5 phr (based on Vamac®) Drapex 6.8, epoxidized soybean oil; Ex 4 included PVC, 10 phr [50/50:PVC Welex blend shown in the table/Vamac® VCX 1012] pre-blended concentrate (net 5 phr Vamac®); Ex 5 included PVC, 20 phr [50/50:PVC Welex blend shown in the table/Vamac® VCX 1012] pre-blended concentrate (net 10 phr Vamac®); and Ex 6 included PVC, 10 phr [50/50:PVC Welex blend shown in the table/Vamac® VCX 1012] pre-blended concentrate +5 phr fiberglass that was added downstream.

| | Control 1 | Control 2 | Ex 1 | Ex. 2 | Ex. 3 | Ex 4 | Ex 5 | Ex. 6 |
|---|---|---|---|---|---|---|---|---|
| Vamac ® Concentrate | | | 20.0 | 20.0 | 20.0 | | | |
| (50/50: Vamac | | | | | | | | |
| Vcx 5500/PVC | | | | | | | | |
| Blend) | | | | | | | | |
| Drapex 6.8 Epoxidized | | | | | 1.5 | | | |
| Soybean Oil | | | | | | | | |
| Vamac ® Concentrate | | | | | | 10.0 | 20.0 | 10.0 |
| (50/50: Vcx 1012/Pvc | | | | | | | | |
| Blend) | | | | | | | | |
| EBAGMA 4934-1 | | | | 0.75 | | | | |
| 3540 Glass - Downstrm | | | | | | | | 5.0 |
| Nyglos 8 (In Feed) | | 10.0 | | | 10.0 | | | |
| Oxyvinyls 216 - Pvc | 100 | | | | | | | |
| Vista 5305 - PVC | | 100 | 100 | 100 | 100 | 100 | 100 | 100 |
| Tm 181 Or Mark 1900 | 2.0 | 2.0 | 2.0 | 2.0 | 2.0 | 2.0 | 2.0 | 2.0 |
| Paraloid K120 | 1.0 | 1.0 | 1.0 | 1.0 | 1.0 | 1.0 | 1.0 | 1.0 |
| Rheolube 165 Parafin | 1.0 | 1.0 | 1.0 | 1.0 | 1.0 | 1.0 | 1.0 | 1.0 |
| Calcium Stearate | 1.5 | 1.5 | 1.5 | 1.5 | 1.5 | 1.5 | 1.5 | 1.5 |
| Irganox 1076 | 0.2 | 0.2 | 0.2 | 0.2 | 0.2 | 0.2 | 0.2 | 0.2 |
| Stearic Acid | 0.5 | 0.5 | 0.5 | 0.5 | 0.5 | 0.5 | 0.5 | 0.5 |

Flexural Modulus

| | | | | | | | | |
|---|---|---|---|---|---|---|---|---|
| psi | 333,000 | 338,000 | 276,000 | 287,000 | 343,000 | 324,000 | 316,000 | 346,000 |
| Standard Deviation | 13,000 | 21,000 | 25,000 | 11,000 | 33,000 | 17,000 | 23,000 | 13,000 |

Tensile Properties @RT(D638)

| | | | | | |
|---|---|---|---|---|---|
| Young's Modulus (Psi) | 452,000 | 469,000 | 374,000 | 385,000 | 471,000 |
| Tensile @Yield (Psi) | 7,500 | 7,500 | 6,400 | 6,200 | 6,500 |
| Elong. @Yield (%) | 3% | 3% | 3% | 3% | 3% |
| Peak Tensile (Psi) | 7,500 | 7,500 | 6,400 | 6,200 | 6,500 |
| Elong @Peak Tensile (%) | 3% | 3% | 3% | 3% | 3% |
| Tensile @Brk (Psi) | 5,700 | 5,900 | 5,400 | 5,400 | 4,700 |
| Elong. @Brk (Psi) | 49% | 74% | 105% | 116% | 55% |

Notched Izod Impact @RT (D638 Tensile Bar)

| | | | | | | | | |
|---|---|---|---|---|---|---|---|---|
| Impact (Ft-Lb/In) | 1.78 | 1.84 | 2.95 | 2.21 | 2.48 | 0.91 | 1.77 | 0.57 |
| Std Dev | 0.86 | 0.91 | 0.84 | 0.53 | 1.41 | 0.36 | 0.15 | 0.05 |
| Failure Mode | Brittle | Brittle | Brittle– | Brittle– | Brittle | Brittle | Brittle | Brittle |
| | | | Ductile | Ductile | | | | |

Notched Izod Impact @0° C. (D638 Tensile Bar)

| | | | | | |
|---|---|---|---|---|---|
| Impact (Ft-Lb/In) | 0.49 | 2.05 | 0.89 | 2.38 | 2.28 |
| Std Dev. | 0.11 | 1.85 | 0.16 | 1.63 | 1.50 |
| Failure Mode | Brittle | Brittle | Brittle | Brittle | Brittle |

Dynatup Instrumented Impact @RT

| | | | | | |
|---|---|---|---|---|---|
| Deflect @Failure (Mm) | 13.7 | 5.9 | 14.7 | 14.7 | 6.6 |
| Std Dev | 0.3 | 5.3 | 0.4 | 0.3 | 3.0 |
| Total Energy (J) | 57.3 | 18.4 | 57.8 | 58.5 | 17.5 |
| Std Dev | 3.1 | 25.7 | 2.0 | 1.8 | 14.6 |
| Failure Type | Ductile | Brittle | Ductile | Ductile | Brittle |

Dynatup Instrumented Impact @0° C.

| | | | | | |
|---|---|---|---|---|---|
| Deflect @Failure (Mm) | 3.4 | 2.8 | 10.0 | 14.8 | 3.4 |
| Std Dev. | 1.2 | 0.6 | 5.1 | 0.1 | 1.2 |
| Total Energy (J) | 2.9 | 2.8 | 37.2 | 66.7 | 6.1 |
| Std Dev | 0.8 | 0.9 | 30.7 | 1.1 | 3.6 |
| Failure Type | Brittle | Brittle | Brittle | Ductile | Brittle |
| HDT @264 Psi (° C.) | 62.7 | 62.7 | 59.9 | 60.7 | 60.1 |

Capillary Rheology @190° C.

| | | | | | | | | | |
|---|---|---|---|---|---|---|---|---|---|
| Shear Rate (1/sec) | 10.0 | 9153 | 9323 | 14550 | 15489 | 17317 | 10634 | 10050 | 11971 |
| | 100.2 | 2055 | 2298 | 3209 | 3493 | 3718 | 2564 | 2489 | 2878 |
| | 501.2 | 808 | 846 | 1139 | 1115 | 1189 | 903 | 873 | 950 |
| | 1002.3 | 510 | 520 | 694 | 692 | 712 | 535 | 516 | 557 |
| | 2004.6 | 306 | 308 | 381 | 386 | 387 | 302 | 291 | 316 |
| | 3006.9 | 220 | 224 | 263 | 269 | 267 | 213 | 206 | 222 |
| | 4009.1 | 174 | 174 | 199 | 206 | 205 | 165 | 160 | 172 |
| | 5011.43 | 142 | 141 | | 159 | 165 | 136 | 130 | 136 |

1. A composition comprising, or produced from, polyvinyl chloride, filler, an impact strength-retaining amount of an elastomer, and optionally an ethylene copolymer, an anhydride- or acid monoester-modified polyolefin, or combinations thereof wherein
the filler includes glass fiber, hollow glass microspheres, CaCO₃, silica, calcium silicate, calcium metasilicate, clay, mica, talc, alumina trihydrate, magnesium hydroxide, metal oxides, or combinations of two or more thereof;
the elastomer comprises repeat units derived from one or more alkyl (meth)acrylates, optionally ethylene, and further optionally an acid cure site monomer;
the ethylene copolymer comprises repeat units derived from ethylene and alky (meth)acrylate, vinyl acetate, (meth)acrylic acid, fully or partially neutralized (meth)acrylic acid, or combinations of two or more thereof; and
the acid anhydride, acid monoester, or acid cure site includes maleic anhydride, itaconic anhydride, fumaric anhydride, maleic acid monoesters, itaconic monoesters, fumaric acid monoester, a salt of thereof, combinations of two or more thereof.

2. The composition of claim 1 wherein the filler is the glass fiber, mineral filler, or combinations thereof.

3. The composition of claim 2 wherein composition comprises the ethylene copolymer and the ethylene copolymer is ethylene butylacarylate carbon monoxide copolymer, ethylene vinyl acetate carbon monoxide copolymer, or combinations thereof.

4. The composition of claim 3 wherein the elastomer include the acid cure site and further optionally an acid cure site monomer.

5. The composition of claim 1 further comprising an ethylene copolymer comprising repeat units derived from ethylene and alky (meth)acrylate, vinyl acetate, (meth)acrylic acid, or combinations of two or more thereof, and optionally a second polymer comprising a reactive hydrogen group or epoxide group.

6. The composition of claim 2 further comprising a second polymer including dialcohol, diacid, diamine, epoxide, or combinations of two or more thereof.

7. The composition of claim 6 wherein the second polymer includes ethylene butylacrylate glycidyl methacrylate, expoxidized soybean oil, or combinations thereof.

8. The composition of claim 2 wherein the elastomer comprises repeat units derived from one or more alkyl (meth)acrylates, optionally ethylene, and further optionally an acid cure site monomer.

9. The composition of claim 8 further comprising an ethylene copolymer comprising repeat units derived from ethylene and alky (meth)acrylate, vinyl acetate, (meth)acrylic acid, or combinations of two or more thereof, and optionally a second polymer comprising a reactive hydrogen group or epoxide group.

10. The composition of claim 9 further comprising the second polymer including dialcohol, diacid, diamine, epoxide, or combinations of two or more thereof.

11. The composition of claim 10 wherein the second polymer includes ethylene butylacrylate glycidyl methacrylate, expoxidized soybean oil, or combinations thereof.

12. A process comprising combining an impact strength-retaining amount of an elastomer, a filler, polyvinyl chloride, and optionally an ethylene copolymer, an anhydride- or acid monoester-modified polyolefin, or combinations thereof, to produce a blend wherein
the filler includes glass fiber, hollow glass microspheres, CaCO₃, silica, calcium silicate, calcium metasilicate, clay, mica, talc, alumina trihydrate, magnesium hydroxide, metal oxides, or combinations of two or more thereof;
the elastomer comprises repeat units derived from one or more alkyl (meth)acrylates, optionally ethylene, and further optionally an acid cure site monomer;
the ethylene copolymer comprises repeat units derived from ethylene and alky (meth)acrylate, vinyl acetate, (meth)acrylic acid, fully or partially neutralized (meth)acrylic acid, or combinations of two or more thereof; and
the acid anhydride, acid monoester, or acid cure site includes maleic anhydride, itaconic anhydride, fumaric anhydride, maleic acid monoesters, itaconic monoesters, fumaric acid monoester, a salt of thereof, combinations of two or more thereof; and
the combining is carried out under a condition sufficient to prevent or minimize the reduction of impact strength of the blend, to reduce the molten viscosity of the blend, or to minimize the loss in stiffness (flexural modulus) of the blend, in comparison to a blend without the modifier.

13. The process of claim 12 wherein the elastomer is crosslinked before being combined with the filler, the polyvinyl chloride, and optionally the ethylene copolymer, the anhydride- or acid monoester-modified polyolefin, or combinations thereof.

14. The process of claim 12 wherein the elastomer is crosslinked during combining with the filler, the polyvinyl chloride, and optionally the ethylene copolymer, the anhydride- or acid monoester-modified polyolefin, or combinations thereof.

15. The process of claim 12 wherein process comprises combining the elastomer, the filler, and optionally the ethylene copolymer, the anhydride- or acid monoester-modified polyolefin, or combinations thereof to produce a blend and, thereafter, combining the blend with the polyvinylchloride.

16. The process of claim 15 wherein the elastomer is the poly(meth)acrylate, the filler is the glass fiber, and the process further comprises combining the ethylene copolymer, the anhydride- or acid monoester-modified polyolefin.

17. The process of claim 15 wherein the elastomer comprises repeat units derived from ethylene and alkyl (meth)acrylate, the filler is the glass fiber, and the process further comprises combining the ethylene copolymer, the anhydride- or acid monoester-modified polyolefin.

18. The process of claim 16 wherein the process further comprising maleic anhydride-modified polyethylene, polypropylene, or combinations thereof.

19. The composition of claim 17 wherein the process further comprising maleic anhydride-modified polyethylene, polypropylene, or combinations thereof.

20. A article comprising or produced from a composition wherein the article includes decorative moldings inside or outside of a house, railroad ties, picture frames, furniture, porch decks, railings, window moldings, window components, door components, roofing systems, sidings, pellets, slugs, rods, ropes, sheets, or molded articles and the composition is as recited in claim 1.
